(19) United States
(12) Patent Application Publication
(10) Pub. No.: US 2002/0146275 A1
(43) Pub. Date: Oct. 10, 2002

(54) RING BINDER

(76) Inventor: Jacques Gerriet, Fleury Sur Andelle (FR)

Correspondence Address: CANTOR COLBURN, LLP, 55 GRIFFIN ROAD SOUTH, BLOOMFIELD, CT, 06002

(21) Appl. No.: 09/829,371

(22) Filed: Apr. 9, 2001

(51) Int. Cl. B42F 3/00; B42F 3/04; B42F 13/12

(52) U.S. Cl. 402/70

(57) ABSTRACT

A binder with two ring systems, of a type comprising a base supporting at least two rings, is provided herein. The binder includes a cover having two boards joined together by a spine, one of the boards taking a first ring system immediately adjacent to the spine, and the other board taking a second ring system parallel to the first and adjacent to an edge of the latter board opposite the spine. The binder also includes at least one component for the releasable fixing of one ring system. The at least one component includes a rectangular plastic plate having on each of its longitudinal edges and on one of its transverse edges at least one clamp forming a slide into which the base can be slid, and an overlay molded with the plate and hinged thereto by a strip, the length of the overlay being approximately equal to the distance between two consecutive rings so that the overlay can be inserted with a snap action between the latter to immobilize the plate.

### FIELD OF THE INVENTION

The present invention relates to a ring binder for perforated sheets.

### BACKGROUND OF THE INVENTION

To alleviate the problem of the waste of space in the archiving of conventional ring binders, the use of binders containing two ring systems for holding perforated sheets is known.

These double ring-system binders comprise a cover consisting of two boards joined together by a spine. One of the boards takes a ring system immediately adjacent to this spine and the other board takes a second ring system oriented in the same direction as the first and adjacent to the edge of the second board opposite the spine. The thickness of the spine is such as to correspond approximately to the sum of the heights of the parts of the rings holding the perforated sheets.

This type of binder is capable of archiving a number of perforated sheets corresponding to the total width of the spine because of the presence of the two ring systems, one on each of the boards of the binder.

This type of binder is however expensive because in order to support the two ring systems, the cover must be made of a material, and have dimensions, particularly thickness, capable of supporting the extra weight due to its archiving capacity which is greater than that of a normal ring binder.

### SUMMARY OF THE INVENTION

One object of the invention is to provide a binder which, although having a large archiving capacity, is of a reasonable cost.

Another object of the invention is to provide a binder, the cover of which can be the subject of at least a second use.

According to the invention, the binder with two ring systems, of a type having a base supporting at least two rings, includes:

a cover consisting of two boards joined together by a spine, one of the boards taking a first ring system immediately adjacent to the spine, and the other board taking a second ring system parallel to the first and adjacent to the edge of the latter board opposite the spine, and

at least one component for the releasable fixing of one ring system including:

a rectangular plastic plate having on each of its longitudinal edges and on one of its transverse edges at least one clamp forming a slide into which the base can be slid, and

an overlay molded with the plate and hinged to it by a strip, the length of the overlay being approximately equal to the distance between two consecutive rings so that it can be inserted with a snap action between the latter.

In accordance with other advantageous characteristics of the invention,

each of the transverse edges of the overlay includes a semi-circular notch whose diameter is at least equal to the diameter of the rings,

the height of the strip is at least equal to the height of the clamps,

the cover includes two flaps, one adjacent to the opposite longitudinal edge of each board from the longitudinal edge connected to the spine.

one of the flaps supports a male part of a press stud designed to engage in a female part of a press stud supported by the other flap.

### BRIEF DESCRIPTION OF THE FIGURES

To enable the invention to be understood clearly, it is described with reference to the attached drawing of the binder to which it relates, in which:

FIG. 1 is a perspective view of the binder, the binder being in the open position,

FIG. 2 is a perspective view showing a means of releasable fixing into the ring system of this binder.

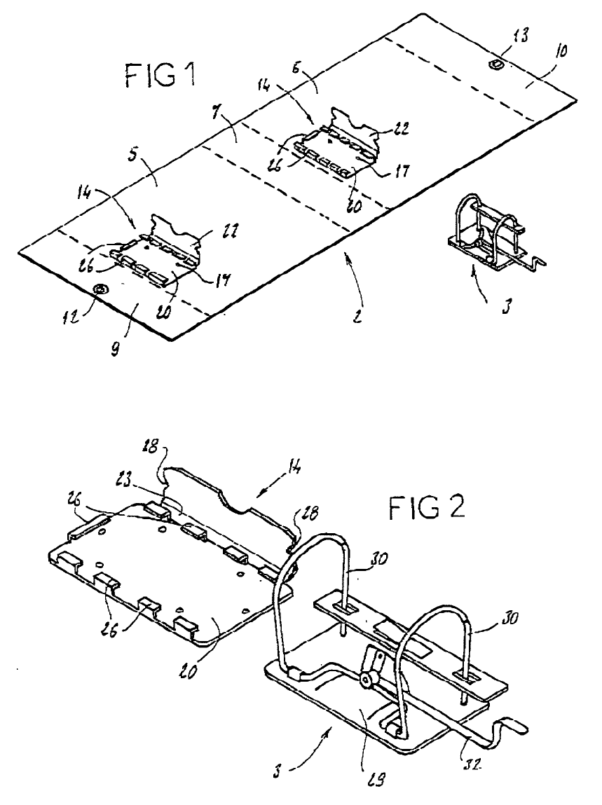

### DETAILED DESCRIPTION OF THE PREFERRED EMBODIMENT

The binder comprises a cover 2 and two ring systems 3 capable of taking perforated sheets.

The cover 2, which is made of board covered with a plasticized covering, comprises two boards 5, 6 joined together by a spine 7. The connection between the spine 7 and the two boards 5 and 6 is provided by score lines. A flap 9 is connected to the board 5 by a score line along its opposite edge to its edge connected to the spine 7. Symmetrically, a flap 10 is connected to the board 6 along its opposite edge to its edge connected to the spine 7.

The flap 9 is provided with a male part 12 of a press stud capable of engagement in a female part 13 of this press stud fitted to the flap 10.

Two identical plastic fixing components 14 are fixed to the boards 5 and 6 with rivets 17. One fixing component is riveted to the board 6 immediately adjacent to the spine 7, while the other fixing component is riveted to the board 5 adjacent to the edge of the latter opposite the edge connected to the spine 7.

As shown in FIG. 2, the fixing component 14 comprises a plate 20 to which an overlay 22 is hinged via a strip 23.

The plate 20, which is of rectangular shape, is provided along its longitudinal edges and along one of its transverse edges with clamps 26 forming slides. The strip 23 is connected to a longitudinal edge of the plate 20 by a film hinge. The width of the strip 23 is greater than the height of the clamps 26. The overlay 22, which is of rectangular shape and is connected to the strip 23 by a film hinge, has two semi-circular notches 28 in each of its transverse edges. The distance between the innermost ends of each of the notches 28 is equal to the distance between two consecutive rings of a ring system 3.

Attachment of a ring system 3, which comprises a base 29 and two rings 30 with a lever 32 to open them, is by engaging the base 29 in the clamps 26 of the plate 20, until the base 29 is up against a clamp 26 on the transverse edge of the plate 20.

However, in this position, the connection of the ring set 3 to the fixing component 14 has a degree of freedom.

This degree of freedom is eliminated by engaging the overlay 22 between two rings 30. In this position of the overlay 22 the ring system 3 is completely immobilized relative to the fixing component 14.

Because of the strip 23, the overlay 22 lies on top of the clamps 26 when in the locking position on the fixing component. The overlay 22 is then approximately parallel to the plate 20.

To remove the fixing component [sic] 3, e.g. when it has reached its maximum storage capacity, the overlay 22 is pivoted to a position approximately perpendicular to the plate 20. Once the overlay is in this position, the ring system 3 can be slid through the clamps 26 and removed from the fixing component 14.

The now full ring system 3 can then be placed in a storage box.

A new ring system 3 can then be mounted on the component of the cover 2. The life of the cover 2, which is expensive, can therefore be extended.

It goes without saying that the invention is not limited to the embodiment described above but that on the contrary it embraces all alternative embodiments.

1. Binder with two ring systems, of a type comprising a base supporting at least two rings, comprising:
a cover including two boards joined together by a spine, one of the boards taking a first ring system immediately adjacent to the spine, and the other board taking a second ring system parallel to the first and adjacent to an edge of the latter board opposite the spine, and
at least one component for the releasable fixing of one ring system comprising:
a rectangular plastic plate comprising on each of its longitudinal edges and on one of its transverse edges at least one clamp forming a slide into which the base can be slid, and
an overlay molded with the plate and hinged thereto by a strip, the length of the overlay being approximately equal to the distance between two consecutive rings so that the overlay can be inserted with a snap action between the latter to immobilize the plate.

2. Binder according to claim 1, wherein transverse edges of the overlay comprise a semi-circular notch whose diameter is at least equal to a diameter of the rings.

3. Binder according to claim 1, wherein a height of the strip is at least equal to a height of the clamps.

4. Binder according to claim 1, wherein the cover comprises two flaps, one adjacent to an opposite longitudinal edge of each board from the longitudinal edge connected to the spine.

5. Binder according to claim 4, wherein one of the flaps supports a male part of a press stud designed to engage in a female part of a press stud supported by the other flap.
